(19) United States
(12) Patent Application Publication
(10) Pub. No.: US 2006/0278300 A1
(43) Pub. Date: Dec. 14, 2006

(54) Process of controlling a drying fluid flow

(76) Inventor: Gerard Coudamy, Limoges (FR)

Correspondence Address: YOUNG & THOMPSON, 745 SOUTH 23RD STREET, 2ND FLOOR, ARLINGTON, VA, 22202, US

(21) Appl. No.: 11/414,214

(22) Filed: May 1, 2006

(30) Foreign Application Priority Data
Apr. 29, 2005 (FR) 05,04377

(51) Int. Cl. B67C 3/00; B65B 31/00

(52) U.S. Cl. 141/5

(57) ABSTRACT

Process of controlling a hot fluid flow passing, on the one hand, through hollow products (4) placed on a support (3) and, on the other hand, through the passages (9) located around these products, consisting in adjustably blocking said passages (9) by placing obstacles (10), composed of a more or less thick layer of material, on the support (3), after products (4) have been put in place.

This invention relates to problems encountered owing to the circulation of the flow of baking fluids and/or drying fluids in baking and/or drying facilities.

This invention relates to a process of controlling a fluid flow such as of hot air or hot combustion gases, for baking, drying or others of industrial ceramic parts or baked clay traversed by cavities. Usually, these products are arranged on supports or grids, the supports loaded in this way then being placed in a chamber into which the hot air is blown such that said cavities are parallel to the direction of hot air circulation.

The hot air then circulates, on the one hand, in the cavities and, on the other hand, between the products.

It turns out that the pressure drop that the air flow circulating in the cavities undergoes is much greater than that caused by the passage of air around the products, such that the hot air flow tends to be directed there or the flow resistance is the weakest, so much that it is estimated that for a given section, the air flow passing between the products is almost fifteen times greater than that passing within the products. This leads to major energy loss and heterogeneity of the flow crossing the products, mainly when the loading of the products varies, and especially when their dimensions change.

In the devices in which the products are arranged with their cavities oriented perpendicularly to the support for which the air crosses said products and said support, determination of the characteristics of the porosity of said support is known so as to partially rebalance the air pressure drops between the inside and outside of the products. This balancing system never makes it possible to obtain a homogenous flow because the pressure drop in the support is always added to the pressure drop in the cavities. The pressure drop in the support is greater, the shorter the distance between the inside and outside of the products. The major disadvantage is that the power consumed by the ventilation system increases.

The ratio of the internal and external air flow rates in the products varies greatly with the pressure drops of the support and the products, values from ½ to 1/10 being found.

It is the same for all operations that use a hot air current, whether for treatment of industrial ceramic parts such as filters, a catalyst support with a cellular structure or else for operations of oil removal, elimination of organic binders or even of baking.

In certain applications, such as the one described in Patent DE 22 52 976, walls are provided on both sides of each of the objects to be treated so as to induce hot air circulation along the external surfaces of said objects.

For other applications, such as the one described in Patent NL 273 332, only the internal space of the products must be crossed by the hot air stream. In this case, a screen is positioned on the support, around the products to be treated, in order to channel the hot air circulation to the inside of the cavities of said products while preventing any air circulation between said products.

Such a device makes it possible to increase the efficiency of the facility in a quite interesting manner, but has the disadvantage of requiring a screen of a shape suited to the dimensions of the support, to the shape and number of the products placed on said support.

This results in the necessity of providing, stockpiling and handling as many screens as there are possible support/article configurations.

The object of this invention is to eliminate this state of affairs by proposing the implementation of a screen that can easily adapt itself to the facility and to the products used.

The process of controlling the hot fluid flow passing, on the one hand, through the hollow products placed on the support and, on the other hand, through the passages located around these products, consists in adjustably blocking said passages by placing obstacles composed of a more or less thick layer of material on the support, after the products are in place.

The process according to the invention is again noteworthy in that:

when the products are placed on the support with their cavities positioned perpendicular to said support, the obstacles are positioned at the base of the passages located between the products,

when the products are placed on the support with their cavities positioned parallel to said support, the sides are positioned along the longitudinal edges of the support, and each obstacle is formed transversely between said sides,

an obstacle is set up transversely on each row of products,

each obstacle is composed of parts filling the spaces between the products on which it is placed, of parts filling the free spaces between the products located on the side, and the sides, and of a layer extending on the upper surface of the products,

the material comprising the obstacles is made up of three-dimensional elements such as granulates, balls, cubes or other polyhedrons,

the dimension of the elements is greater than that of the support meshes,

when the dimension of the elements is less than that of the support meshes, an additional support that is porous to air is located on the support before placing the products to be dried,

the thickness “h” of the layer of elements controls the amount of air that can circulate in the passages,

when the passages are blocked at their base by a layer of paste or viscous liquid, an additional support that is porous to air is arranged on the support before placing products to be treated to hold said paste or said viscous liquid.

The process according to the invention can be used for any operation using a hot air fluid such as: drying of raw products before baking, of honeycomb articles, of catalysts with a cellular structure; oil removal; elimination of organic binders, or even baking, the material of the obstacles and of the support being selected to resist the treatment temperatures.

The invention will be better understood from the following description given by way of a nonlimiting example with reference to the attached drawings in which:

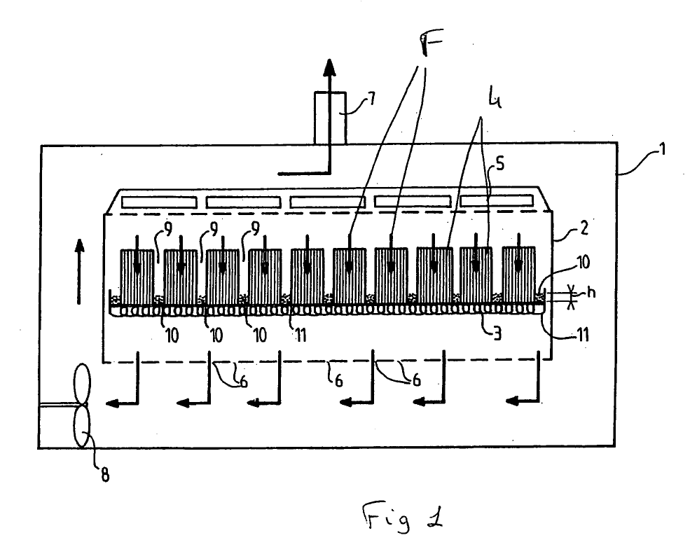

FIG. 1 shows a facility implementing a first embodiment of the invention,

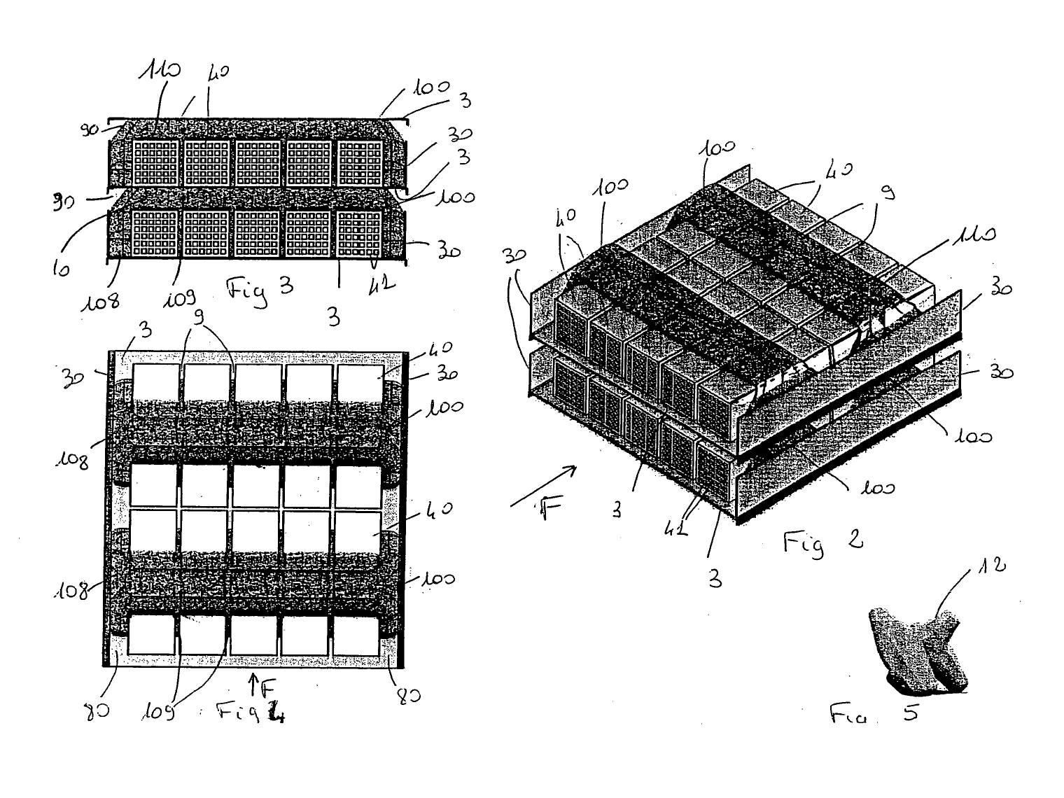

FIGS. 2 to 4 are front and top perspective views, respectively, of a stack of products intended to be treated, using a second variant embodiment of the invention,

FIG. 5 shows one example of the product designed to be used in the invention.

The process according to this invention consists in adjustably blocking the passages in which the air can pass between the hollow products to be dried such that all of the drying air or almost all of the drying air is forced to pass within said products.

The arrangement shown in FIG. 1 is made up of a chamber 1 within which a second chamber 2 is located, in which there is a support 3 bearing the products 4 to be dried.

In the variant embodiment of the invention shown in FIG. 1, the products 4 are arranged on the support 3 with their cavities positioned vertically. The cavities are then arranged parallel to the direction F of treatment air circulation and perpendicular to the support 3.

The chamber 2 is supplied with a drying air flow through openings 5. After having crossed the support 3, this drying air leaves the chamber 2 through the holes 6 in the chamber 1 from where it is discharged through the discharge opening 7. A fan 8 can be positioned to accelerate the circulation of the drying air flow.

The process according to the invention consists in greatly reducing or even completely suppressing the air flow that passes between the products 4 to arrive directly at the meshes of the support 3 through the spaces 9.

To do this, more or less thick obstacles 10 are placed at the base of the spaces 9, after the products 4 have been put in place.

According to a first embodiment of the process, the obstacles 10 are composed of three-dimensional elements such as balls, cubes, granulates, polyhedrons or articles 12 such as the one shown in FIG. 5. The article 12 has a shape similar to the concrete blocks that are known under the trademark CORE-LOCK™ and that are designed for making piers or breakwaters.

The dimensions of the three-dimensional elements used to make up the obstacles 10 can be greater than those of the meshes of the support 3 in order not to pass through.

But then, these dimensions are such that the spaces that exist between these elements are large such that they do not sufficiently slow down the air flow.

To enhance this slowing-down, elements of smaller dimensions must be chosen, but then it is necessary to have a means for preventing them from passing through the support 3.

To do this, an additional porous support 11 of small thickness is placed on the support 3.

The products 4 as well as the obstacles 10 are placed on this additional support 11. Then, elements of small dimensions, balls of small diameter in the example shown, can be used, such that the interstices between said balls are small. The height “h” of the thickness of the layer of balls makes it possible to control the magnitude of the air flow that will pass between the balls.

It thus is possible to control the amount of air that will pass through the passages 9 relative to the amount of air that will pass through the products 4 via their cavities.

According to a second embodiment of the process according to the invention, a paste or a sufficiently viscous liquid can be placed on the additional support 11 in order not to be able to cross said support 11. In this case, there is no longer any air passage through the passages 9 that are completely blocked at their base.

The support 11 can be of any suitable material, for example a nonwoven textile fiber mat or an organic or ceramic foam.

Once drying has ended, the products 4 are removed using conventional handling means, and the balls or granulates comprising the obstacles 10 are removed by sweeping or suction.

When a viscous liquid is used, removal takes place by suction.

When a paste is used, it is removed by means of scrapers after having removed the products 4.

In the variant embodiment of the invention shown in FIGS. 2 to 4, the products 40 are arranged on the support 3 with their cavities 41 positioned horizontally. The cavities are then parallel to the direction F of treatment air circulation and to the surface of the support 3.

This horizontal arrangement of products 4 facilitates the formation of stacks of supports 3 bearing products 40 and allows simultaneous treatment of a large number of products 40 arranged in superimposed layers.

In such an arrangement, the treatment air can circulate in the spaces 9 left open between the products 40, as in the arrangement shown in FIG. 1, but likewise for each layer of products in the interstices that are inevitably present between the upper surfaces of said products 40 and the support 3 positioned on them to support a second layer of products 40.

In order to solve the problem of the loss of efficiency of the facility, the invention proposes setting up obstacles 100 preventing or reducing the passage of air in the spaces 9 and in said interstices at the same time.

To do this, after the products 40 are placed on the support 3, material is dumped so as to form an obstacle 100 arranged transversely relative to the direction F of air circulation.

As shown in the drawing, sides 30 are positioned along the lengthwise edges of the support 3 and each obstacle 100 extends transversely between said sides 30. An obstacle 100 is set up transversely on each row of products 40, for example completely over the central part of said products.

Each obstacle 100 is composed of parts 109 filling the spaces 9 between the products 40 on which it is placed, of parts 108 filling the free spaces between the products 40 arranged on the side, and the sides 30, and of a layer 110 extending on the upper surface of the products 40.

The support 3 that is designed to bear another layer of products 40 is positioned flat on the top of the obstacles 100. The interval 90 that is thus formed between the upper surfaces of the products 40 and the support 3 of the upper level is blocked by the obstacles 100.

The obstacles 100 can, as described above, be composed of three-dimensional elements of shapes and dimensions adapted to the pressure drop desired around products 40.

In this embodiment, the three-dimensional elements such as the article 12 shown in FIG. 5 are especially well adapted, since their shapes allow formation of stable piles with a significant slope that reduces the number of articles to be used to form each obstacle.

This invention is not limited to the above-described examples that relate to the drying of raw products before their baking.

This process can, in fact, be used for operations of oil removal, elimination of organic binders or baking.

It is not uncommon that when honeycomb products are made by extrusion, oil is used to facilitate extrusion. Then, this oil must be eliminated; this requires an air flow at a temperature typically of between 80° and 140°.

Likewise, to eliminate organic binders, an air flow at a temperature of between 170° and 400° is used, and, for carbon-containing binders, at a temperature of between 400° and 800°.

This process can even be used for baking industrial ceramic parts or baked clay products.

Then, products that are resistant to the temperatures used must be used for the parts 4, 40.

In the particular case of high-temperature baking, for the balls 10 or the like, it will be necessary to use ceramic products, and for the additional support 11, products able to resist said temperatures such as the ceramic foam support described in Patent FR 2 794 632.

1. Process of controlling a hot fluid flow passing, on the one hand, through hollow products (4, 40) placed on a support (3) and, on the other hand, through the passages (9, 80, 90) located around these products, consisting in adjustably blocking said passages (9, 80, 90) by placing obstacles (10, 100) composed of a more or less thick layer of material on the support (3), after the products (4) have been put in place.

2. Process according to claim 1, according to which when the products (4) are placed on the support (3) with their cavities positioned perpendicular to said support (3), the obstacles (10) are positioned at the base of the passages (9) located between the products (4).

3. Process according to claim 1, according to which when the products (40) are located on the support (3) with their cavities positioned parallel to said support (3), sides (30) are positioned along the longitudinal edges of the support (3), and each obstacle (100) is formed transversely between said sides (30).

4. Process according to claim 3, according to which an obstacle (100) is set up transversely on each row of products (40).

5. Process according to claim 3, characterized in that each obstacle (100) is composed of parts (109) filling the spaces (9) between the products (40) on which it is placed, of parts (108) filling the free spaces between the products (40) placed on the side, and the sides (30), and of a layer (110) extending on the upper surface of the products (40).

6. Process according to claim 1, according to which the material comprising the obstacles (10, 100) is made up of three-dimensional elements such as granulates, balls, cubes or other polyhedrons.

7. Process according to claim 6, according to which the dimension of the elements is greater than that of the meshes of the support (3).

8. Process according to claim 6, according to which the dimension of the elements is less than that of the meshes of the support (3), and an additional support (11) that is porous to air is located on the support (3) before placing products to be dried (4, 40).

9. Process according to claim 6, wherein the thickness “h” of the layer of elements controls the amount of air that can circulate in the passages (9, 80, 90).

10. Process according to claim 2, according to which the passages (9) are blocked at their base by a layer of paste or a viscous liquid, an additional support (11) that is porous to air being arranged on the support (3) before placing products to be treated to hold said paste or said viscous liquid.

11. Process according to claim 1, wherein it can be used for any operation using a hot air fluid such as: drying of raw products before baking, of honeycomb parts, of catalysts with a cellular structure; oil removal; elimination of organic binders, or even baking, the material of the obstacles (10, 100) and the additional support (11) being selected to resist treatment temperatures.
